(19) United States
(12) Patent Application Publication
(10) Pub. No.: US 2018/0004802 A1
(43) Pub. Date: Jan. 4, 2018

(54) USER INTERFACE FOR SEARCHING REFERENCED INFORMATION

(71) Applicant: Navigate Surgical Technologies, Inc., Vancouver (CA)

(72) Inventor: Ehud (Udi) DAON, North Vancouver (CA)

(21) Appl. No.: 15/466,616

(22) Filed: Mar. 22, 2017

Related U.S. Application Data
(63) Continuation-in-part of application No. 15/050,140, filed on Feb. 22, 2016.
(60) Provisional application No. 62/312,318, filed on Mar. 23, 2016.
(60) Provisional application No. 62/127,246, filed on Mar. 2, 2015.
(60) Provisional application No. 62/252,276, filed on Nov. 6, 2015.

(51) Int. Cl. G06F 17/30; G06F 3/0488; G06F 3/0484

(52) U.S. Cl. CPC G06F 17/30398; G06F 17/30554; G06F 3/0484; G06F 3/04886

(57) ABSTRACT

The present invention involves a method and associated software program and computing system that employ a user interface for searching information referenced on a display of the computing system. When the computing system displays on a display device an on-display reference to a body of information accessible to the computing system, then, when an on-display indicator of an input device to the computing system coincides with at least a first portion of the on display reference, a least a second portion of the on display reference is automatically replaced by a search box configured for searching the body of information. The method is directed to the sparing use and decluttering of precious on-display screen area of display devices.

### CROSS-REFERENCE TO RELATED APPLICATIONS

The present invention claims priority under 35 U.S.C. §119(e) of Provisional Patent Application Ser. No. 62/312,318, filed Mar. 23, 2016, and claims priority under 35 U.S.C. §120 as a continuation-in-part of U.S. patent application Ser. No. 15/050,140, filed on Feb. 22, 2016, which claims priority under 35 USC 119(e) of U.S. Provisional Patent Applications Ser. No. 62/127,246, filed Mar. 2, 2015, and 62/252,276, filed Nov. 6, 2015, both with the same title, the disclosures of which are incorporated by reference herein. Additionally, the present application is a continuation-in-part of PCT International Application Serial Number PCT/IL2012/000363, filed Oct. 21, 2013, and a continuation-in part of U.S. patent application Ser. No. 13/598,484, filed Jan. 16, 2014, both of which claim priority under 35 U.S.C. §119(e) of U.S. Patent Provisional Applications Ser. Nos. 61/553,058, filed on Oct. 28, 2011, and 61/616,718 and 61/616,673, both of which were filed Mar. 28, 2012, the disclosures of which are incorporated by reference herein. The present application also claims priority under 35 U.S.C. §120 as a continuation-in-part of U.S. patent application Ser. No. 13/822,358, filed Mar. 12, 2013.

### BACKGROUND OF THE INVENTION

### Field of the Invention

The invention relates to the searching of digital information by methods requiring little space on display monitors or low levels of information clutter in order to reduce complexity during critical operations.

### Description of the Related Art

A number of different methods are in use for the display and mining of digital data on suitable display monitors by an operator. At the highest level, information may either be searched via suitable search process steps, or it may be browsed by stepping on some or other organized basis through the body of information. The present invention is directed to the former field of searching a body of information. More particularly, the focus is on methods employing a search box into which alphanumeric texted is typed in order to initiate a search by means of a search routine.

Most typically, a primary page of a graphic user interface (GUI) may comprise a virtual “button”, “tab”, or text-labeled hyperlink, often labeled with the word “Search” in a relevant language, which, when suitably selected by clicking with a selection device such as a software “mouse”, opens a display page comprising a search box into which alphanumeric text may be entered for a search to be conducted. In other cases, the GUI may comprise a search box on the primary page into which alphanumeric text may be entered for a search to be executed.

### SUMMARY OF THE INVENTION

In first aspect of the invention, a computing system is presented comprising at least one memory device; at least one processor in communication with the at least one memory device and having access to a body of information; a display device in communication with the at least one processor; a first user input means in communication with the at least one processor; a computer-readable storage medium with software instructions stored thereon; and a first retrieval means in communication with the at least one processor and configured for retrieving at least the software instructions from the computer-readable storage medium, wherein the at least one processor is configured for retrieving the software instructions from the computer-readable storage medium via the first retrieval means and storing the software instructions in the at least one memory device; and wherein the software instructions when executed by the at least one processor cause the computing system to: display on the display device an on-display reference to the body of information and an on-display indicator representing the first input means; and replace at least a first portion of the on-display reference with a search box configured for receiving alphanumeric search information when an on-display indicator of the at least a first user input means to the computing system designates the on-display reference on the display device. The search box may be configured for receiving the alphanumeric search information from a second user input means. The first user input means may a digital mouse and the second input means is a digital keyboard. In other embodiments the first and second user input means may be the same means and the second input means may be a digital keyboard

There are, however, applications and circumstances that demand a minimum of display clutter. In other cases the actual monitor may be small for practical reasons, and display area may be at a premium. In at least these circumstances an alternative means of accessing searches of relevant information is required that uses less monitor space, is easily accessible, and is intuitive. There is also a need to reduce the load on the operator, who may, for example, be in the midst of a high risk medical procedure and cannot afford to be distracted by misplaced or ill-timed software issues. Similar considerations apply to military digital equipment.

The computer-readable storage medium may have further software instructions stored thereon which when executed by the at least one processor cause the computing system to conduct a search for the alphanumeric search information within the body of information; receive search results in response to the alphanumeric search information received in the search box; and present the search results on the display device.

The body of information may be a database, a body of alphanumeric text, a collection of graphics images, and/or a collection of data file names. The on-display reference may be alphanumeric text, a graphics image, or a tab. The on-display indicator may be a graphic indicator relocatable on the display device by the first input means. The computer-readable storage medium may have software instructions stored thereon which when executed by the at least one processor cause the computing system to generate a visual output including a control button located next to the search box. The designating of the on-display reference by the on-display indicator may particularly comprise the on-display indicator hovering over the on-display reference without selecting the on-display reference. In other embodiments, the designating of the on-display reference by the on-display indicator particularly may comprise selecting the on-display indicator by means of the on-display reference. The selecting of the on-display indicator by means of the on-display reference may comprise operating a button on the first user input means.

In another aspect of the invention a computer-readable storage medium is provided, with software instructions stored thereon, which when executed by at least one processor of a computing system with access to a body of information, cause the computing system to: display on a display device in communication with the computing system an on-display reference to the body of information; and replace at least a first portion of the on-display reference with a search box configured for receiving alphanumeric search information when an on-display indicator of a first user input means to the computing system designates the on-display reference.

The computer-readable storage medium may have further software instructions stored thereon which when executed by the at least one processor cause the computing system to: display the alphanumeric search information in the search box when the alphanumeric search information is input by a user into the computing system via a second user input means; conduct a search for the alphanumeric search information within the body of information; receive search results in response to the alphanumeric search information received in the search box; and present the search results on the display device.

The computer-readable storage medium may have yet further software instructions stored thereon which when executed by the at least one processor, cause the computing system to generate a visual output including a control button located next to the search box.

In another aspect of the invention a method is provided for searching a body of information accessible to a computing system, the method comprising: operating the computing system to display on a display device in communication with the computing device an on-display reference to the body of information; operating a first user input means to the computing system to cause an on-display indicator of the first input means to designate the on-display reference; and automatically replacing at least a portion of the on-display reference with a search box configured for receiving alphanumeric search information when the on-display indicator designates the on-display reference. The method may further comprise conducting a search for the alphanumeric search information within the body of information; receiving search results in response to the alphanumeric search information received in the search box; and presenting the search results on the display device. In a further aspect of the invention, a computer program is provided to execute the several steps of the method above.

In another aspect of the invention a graphic user interface (GUI) is provided for searching a body of information by means of a computing system having a display device and a first user input means, the graphic user interface displayed on the display device and comprising: an on-display reference to the body of information; an on-display indicator of the first user input means; and a search box for receiving alphanumeric search input, wherein the computing system is configured for replacing the on-display reference at least in part by the search box when the on-display indicator designates the on-display reference on the display device. The computing system generating the GUI may configured for displaying within the search box a cursor associated with a second user input means, the cursor indicating a location for entering alphanumeric information by means of the second input means. The computing system may be configured for displaying proximate the text box a search button allowing a search by the computing system for the entered alphanumeric information when the on-display indicator may be used to select the search button.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized as controller, input, and display in conjunction with embodiments of the present invention.

FIGS. 3A and 3B show the user interface of one embodiment of the present invention on the display device of FIG. 2 at two stages of execution.

FIG. 4 shows a flow chart of a method according to one embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The flows charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below are not intended to be exhaustive or limit the invention to the precise form disclosed in the following detailed description. Rather, the embodiments are chosen and described so that others skilled in the art may utilize their teachings.

Before proceeding to describing the present invention in more detail, we consider first some general computing elements supporting the invention. The detailed descriptions that follow are presented in part in terms of algorithms and symbolic representations of operations on data bits within a computer memory representing alphanumeric characters or other information. The hardware components are shown with particular shapes and relative orientations and sizes using particular scanning techniques, although in the general case one of ordinary skill recognizes that a variety of particular shapes and orientations and scanning methodologies may be used within the teaching of the present invention. A computer generally includes a processor for executing instructions and memory for storing instructions and data, including interfaces to obtain and process imaging data. When a general-purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities, observing and measuring scanned data representative of matter around the surgical site. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed to capture the underlying data of an image. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements that impart or manifest a physical organization on the information stored in memory. More than mere abstraction, the data structures are specific electrical or magnetic structural elements in memory, which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein that form part of the present invention; the operations are machine operations. Useful machines for performing the operations of the present invention include general-purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present invention also relates to an apparatus for performing these operations. This apparatus may be specifically constructed for the required purposes or it may comprise a general-purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols, which may or may not require specific hardware or programming to interact. In particular, various general-purpose machines may be used with programs written in accordance with the teachings herein, or it may prove more convenient to construct more specialized apparatus to perform the required method steps. The required structure for a variety of these machines will appear from the description below.

The present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects. Often, but not necessarily, a physical object has a corresponding software object that may collect and transmit observed data from the physical device to the software system. Such observed data may be accessed from the physical object and/or the software object merely as an item of convenience; therefore where “actual data” is used in the following description, such “actual data” may be from the instrument itself or from the corresponding software object or module.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and here the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions, which may include sending additional messages to one or more other objects. The other objects may in turn carry out additional functions in response to the messages they receive. Including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms that are used frequently have specialized meanings in the present context. The term “object” relates to a set of computer instructions and associated data, which may be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers that are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a worldwide network of computers, namely the “World Wide Web” or simply the “Web”. Examples of Browsers compatible with one or more embodiments of the present invention include the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description details such operations in terms of a graphic user interface of a Browser, one or more embodiments of the present invention may be practiced with text based interfaces, or even with voice or visually activated interfaces, that have many of the functions of a graphic based Browser.

Browsers display information, which is formatted in a Standard Generalized Markup Language (“SGML”) or a HyperText Markup Language (“HTML”), both being scripting languages, which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the style sheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system, which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

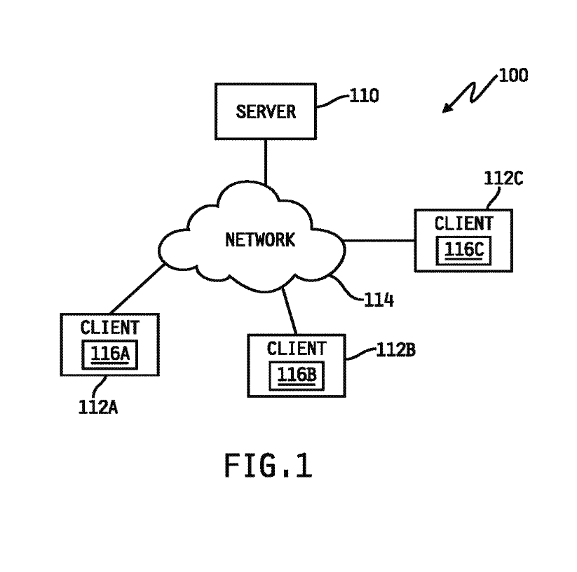

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

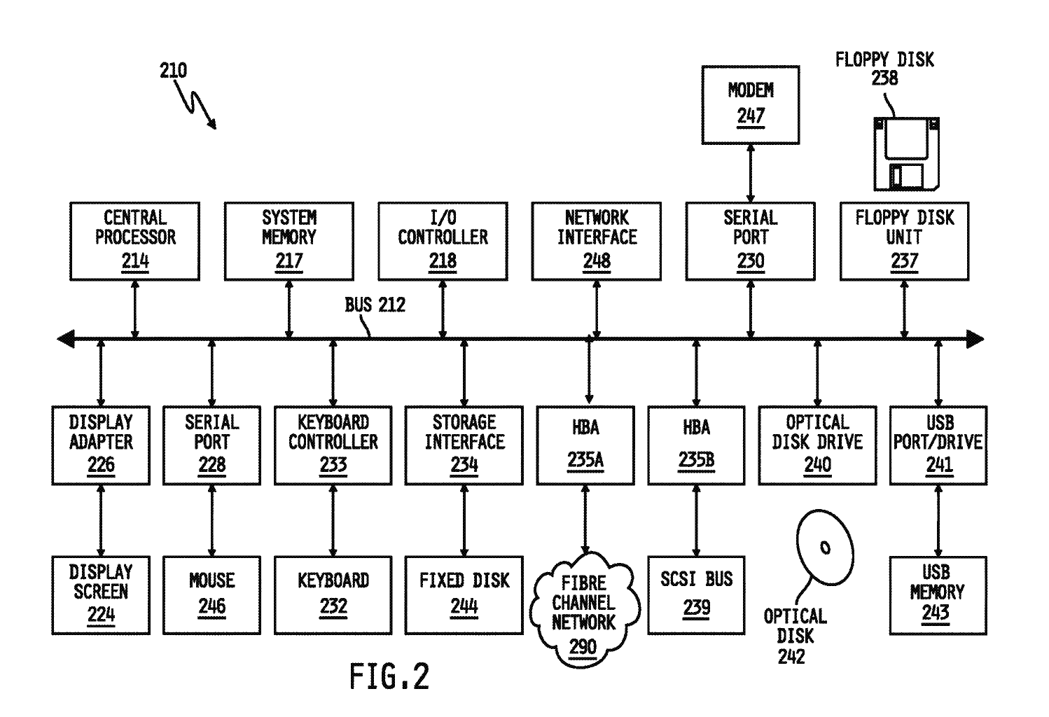

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, a Universal Serial Bus (USB) port/drive 241 for communicating with a USB memory 243, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fiber Channel network 290, host bus adapter (HBA) interface card 235B operative to connect to SCSI bus 239, and optical disk drive 240 operative to receive optical disk 242. Also included are mouse 246 (or other point-and-click device coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS), which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an Internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e. g., document scanners, digital cameras and so on), which alternatively may be in communication with associated computational resources through local, wide-area, or wireless networks or communications systems. Thus, while the disclosure may generally discuss an embodiment where the hardware components are directly connected to computing resources, one of ordinary skill in this area recognizes that such hardware may be remotely connected with computing resources. Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Washington), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNLX is a registered trademark of X/Open Company Limited of Reading, United Kingdom), Linux® (Linux is a registered trademark of Linus Torvalds of Portland, Oreg.), or other known or developed operating system.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above-described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modification to the first signal, whether due to circuit limitations or due to passage through other circuit elements which do not change the informational and/or final functional aspect of the first signal.

In a first aspect of the invention, described schematically at the hand of FIGS. 1 and 2, a computing system is provided, for example system 210 of FIG. 2, comprising at least one memory device, for example memory 217 of FIG. 2; at least one processor, for example central processor 214 of FIG. 2, in communication with the at least one memory device, for example memory 217 of FIG. 2; and a display device, for example display device 224 of FIG. 2, in communication with the processor 214. The computing system has access to a body of information which may be in memory device 217. The computing system further comprises one or more user input devices. Example user input devices include without limitation a keyboard, for example keyboard 232 of FIG. 2, a digital pointing and selection device, for example mouse 246 of FIG. 2 or an equivalent touchpad or track ball, and a touch screen mechanism (not shown) implemented on display device 224. The user input device may employ a pointing device and selection device in conjunction with the touch screen on display device 224. Suitable pointing and selection devices include, but are not limited to passive stylus devices and active stylus devices. A suitable example of an active stylus device is, for example without limitation the induction powered “S-pen” provided by Samsung Electronics of Samsung Town, Seocho-gu, Seoul, South Korea. Alternative embodiments of the invention may employ other sensory devices which interpret human actions as computer instruction. User input devices are in communication with the at least one processor 214 and configured for the entering of input information by an operator into the at least one processor 214.

The computing system may comprise a computer-readable storage medium with software instructions stored thereon; and a first retrieval mechanism in communication with the at least one processor and configured for retrieving at least the software instructions from the computer-readable storage medium. A suitable computer-readable storage medium may be a floppy disk, for example floppy disk 238, a firmware memory, for example memory 243 of a USB “memory stick” or “jump drive” or any other means capable of storing software comprising executable instructions, including for example without limitation a hard disk incorporated in a housing with processor 214, for example fixed disk 244, a storage means external to the housing, or a storage means accessible to processor 214 on a suitable network, for example network 114 of FIG. 1 and fiber channel network 290 of FIG. 2.

The storage medium may be magnetic or optical or may employ any other suitable mechanism for data storage. The first retrieval mechanism may be any one of a floppy disk drive, for example floppy disk unit 237 of FIG. 2, a USB “drive” as part of a “memory stick” or “jump drive” communicating via a Universal Serial Bus (USB), for example USB port/drive 241, an internal or external hard drive, for example the disk reading device of fixed disk 244 of FIG. 2, or any networked drive on networks 114, 290 capable of reading storage mechanisms. The drives may be magnetic or optical, for example optical disk drive 240 of FIG. 2, or may employ any other suitable mechanism for data retrieval. Processor 214 is configured for retrieving the software instructions from computer-readable storage medium 238, 243, 244 via retrieval mechanism 237, 243 and storing the software instructions in memory device 217.

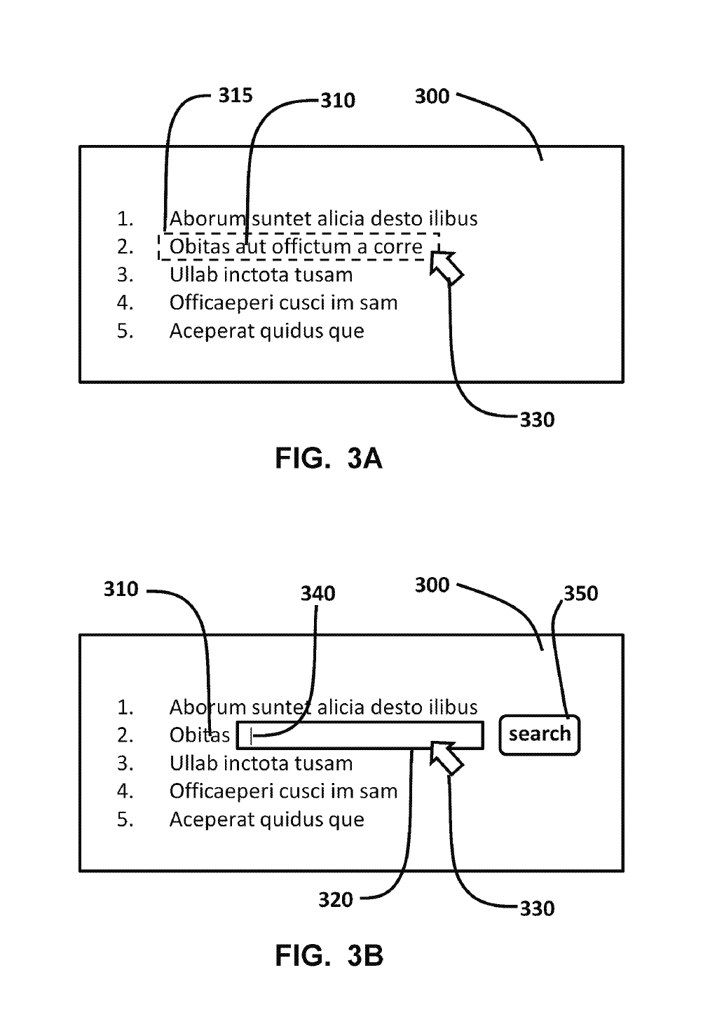

With reference to FIGS. 3A and 3B, the software instructions, when executed by processor 214, cause the computing system to display, on display device 224, on-display reference 310 to the body of information; and replace at least a first portion of on-display reference 310 with search box 320 which is configured for receiving alphanumeric search information when on-display indicator 330 of a first user input mechanism, for example digital mouse 246, to the computing system designates on-display reference 310. The body of information may be any or any nature or type, optionally with portions of the body of information being categorized or otherwise segmented into a sub-set of the entire body of information being displayed within on-display reference 310.

The terms “designates” and/or “designating” are used in the present specification to describe any one of the actions known in general user interface (UI) terminology as “pointing”, “clicking”, “selecting”, or “hovering” using a digital mouse or other pointing and selecting device as described above, for example mouse 246. In employing any of these point and select devices to designate on-display reference 310, on-display reference 310 may be contained within a selection zone demarcated by broken line 315. The designating may be enacted by on-display indicator 330 touching line 315 or any point inside the area demarcated on display device 224 by line 315.

Computer-readable storage medium 238, 243, 244 may further have software instructions stored upon it which, when executed by processor 214, cause the computing system to conduct a search for the alphanumeric search information within the body of information, receive search results in response to the alphanumeric search information received in search box 320; and present the search results on display device 224.

The body of information may be, but is not limited to, a database, a body of alphanumeric text, a collection of graphics images, and/or a collection of data file names. On-display reference 310 may be alphanumeric text, a graphics image and/or a tab. An example of alphanumeric text useful in the present invention may be, for example, without limitation, a title or header of a list or large body of text, the list or body of text itself not being displayed on display device 224. The on-display reference may be supported by a hyperlink to another page of display information. In the embodiment shown in FIGS. 3A and 3B, on-display indicator 330 may be a graphic indicator relocatable on the display device by an input mechanism. For example, on-display indicator 330 may be an on-display arrow, as in the embodiment of FIGS. 3A and 3B, or a cursor relocatable on display device 224 by mouse 246. In other embodiments, a keyboard, for example keyboard 232, may command and relocate on-display indicator 330. In some embodiments a keyboard, for example keyboard 232, may be the only user input mechanism and may be used both to enter data and to relocate on-display indicator 330.

Computer-readable storage medium 238, 243, 244 may have software instructions stored thereon which when executed by processor 214 cause the computing system to generate a cursor within search box 320 to indicate where keyboard 232 enters alphanumeric search information. While in this embodiment the input means for inputting alphanumeric information includes keyboard 232, other types of alphanumeric generation is contemplated for embodiments of the invention, such as touch search input or voice transcription input. Computer-readable storage medium 238, 243, 244 may have software instructions stored thereon which when executed by processor 214 cause the computing system to generate on display device 224 a control button, for example search button 350, located next to search box 320, or other search activation methods may be used such as voice activation (e.g., a specific word to activate the search) or motion sensing (e.g., a specific shake of the device to activate the search).

In another aspect of the invention, described at the hand of FIGS. 3A, 3B, and 2, graphic user interface 300 is provided for searching a body of information by means of a computing system having display device 224 and a user input mechanism, for example digital mouse 246, graphic user interface 300 displayed on display device 224 and the graphic user interface comprising on-display reference 310 to the body of information; on-display indicator 330 of user input mechanism 326; and search box 320 for receiving alphanumeric search input, wherein the computing system is configured for replacing on-display reference 310 at least in part by search box 320 when on-display indicator 330 designates on-display reference 310.

The computing system may be configured for displaying within text box 310 cursor 340 associated with a second user input mechanism, for example keyboard 232 of FIG. 2, cursor 340 indicating a location for entering alphanumeric information by second input mechanism 232. The computing system may be configured for displaying proximate text box 310 a control button, for example search button 350, allowing a search by the computing system for the entered alphanumeric information when on-display indicator 330 selects search button 350. The search action may be enacted by operating input mechanism 246 to cause on-display indicator 330 to substantially coincide with search button 350 and then pressing a button on input mechanism 246, for example the left-click button. Alternatively, the search action may be enacted by pressing a key on the second input means, for example the “ENTER” key on keyboard 232.

In another aspect of the present invention the computer-readable storage medium described above is provided with the software instructions described above stored thereon. When the software instructions are executed by processor 214 of the computing system, they cause the computing system to display on display device 224 on-display reference 310 to the body of information as already described; and to replace at least a first portion of on-display reference 310 with search box 320 configured for receiving alphanumeric search information when on-display indicator 330 of a user input mechanism as described above designates on-display reference 310. The computer-readable storage medium may have further software instructions stored thereon which when executed by the at least one processor, cause the computing system to conduct a search for the alphanumeric search information within the body of information receive and search results in response to the alphanumeric search information received in search box 320 and present the search results on display device 224. As already described the body of information may a database, a body of alphanumeric text, a collection of graphics images, and/or a collection of data file names.

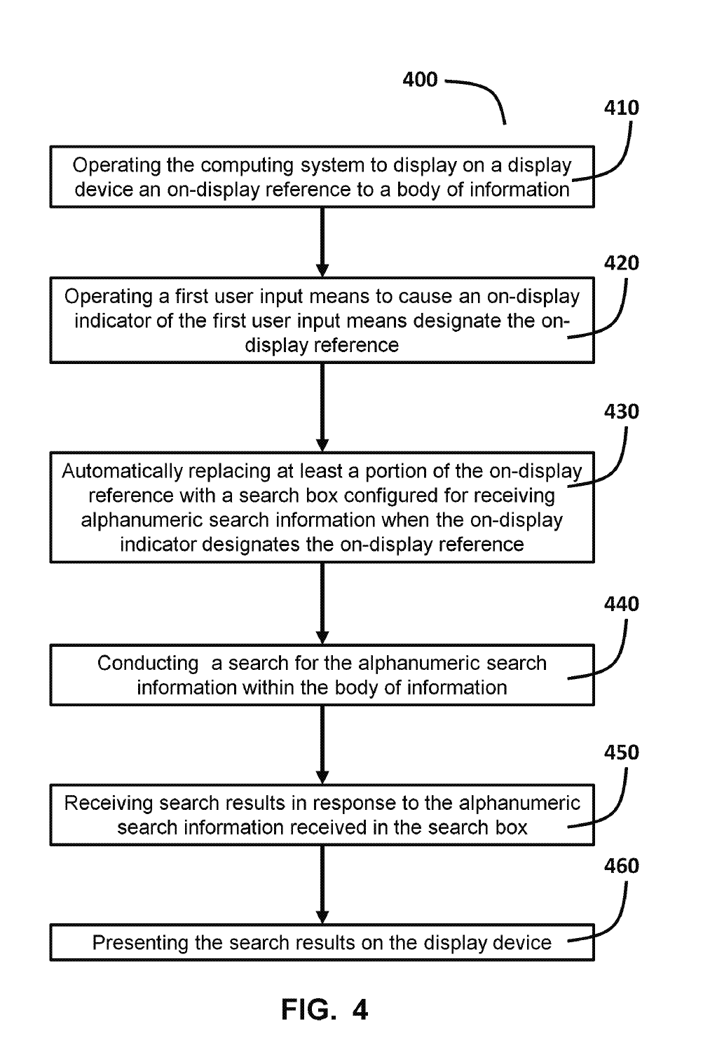

In another aspect of the present invention, described at the hand of FIG. 4, a method [400] is provided for searching a body of information accessible to the computing system, the method comprising: operating [410] the computing system to display on display device 224 in communication with the computing system on-display reference 310 to the body of information; operating [420] a first user input mechanism, which may be digital mouse 246, to cause on-display indicator 330 of input mechanism 246 to designate on-display reference 310; and automatically replacing [430] at least a second portion of on-display reference 310 with search box 320 configured for receiving alphanumeric search information when on-display indicator 330 designates on-display reference 310. The method [400] may further comprise: conducting [440] a search for the alphanumeric search information within the body of information; receiving [450] search results in response to the alphanumeric search information received in search box 330; and presenting the search results on display device 224.

Conducting [440] the search for the alphanumeric search information within the body of information may comprise conducting a search for the alphanumeric search information within a database, within a body of alphanumeric text, among a collection of graphics images, and/or among a collection of data file names. Conducting the search [440] may comprise entering the alphanumeric search information into the computing system via a second user input mechanism, which may be keyboard 232, and displaying the alphanumeric search information in search box 320. The first and second input mechanisms may be the same input mechanism, in which case keyboard 232 functions as both input mechanisms in order to input data. In this respect the function of keyboard 232 may also be fulfilled by a touch screen virtual keyboard on display device 224.

In some embodiments, the search may be a global search amongst every item of the body of information being displayed via on-display reference 310. In other embodiments, the search based on the data entered by cursor 340 may be global in nature and also cross-referenced to the information being displayed via on-display reference 310. In still other embodiments, the on-display reference 310 may include a plurality of subject references, each subject reference associated with a subset of the body of information, and the search based on data entered via cursor 340 may not be global but instead be conducted within the subset of the body of information presented by the selected subject reference displayed on graphic user interface 300. In further embodiments of the invention, the search may be alternatively made globally, cross-referenced, or within a subset by user selection, for example by invoking an additional menu or alternatively by using a special search instruction text within on-display reference 310.

Operating [410] the computing system to display on-display reference 310 comprises operating the computing system to display alphanumeric text, a graphics image and/or a tab. On-display reference 310 may be supported by a hyperlink to information elsewhere in computing system or remotely accessible to computing system. Operating [420] the input mechanism to cause on-display indicator 330 to designate on-display reference 310 comprises operating input mechanism 246 to cause graphic indicator 330 relocatable on display device 224 by input mechanism 246 to designate on-display reference 310. The method [400] may further comprise operating the computing system to generate a visual output including a control button, for example search button 350, located next to search box 320. In a further aspect of the invention a computer program product is provided for implementing the method described above.

Automatically replacing [430] at least a second portion of on-display reference 310 with search box 320 may comprise displaying within search box 420 cursor 450 associated with an alphanumeric information input mechanism, for example keyboard 232, the cursor indicating a location for entering alphanumeric information by, for example, keyboard 232, or other suitable input mechanism.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A computing system, comprising:
at least one memory device, at least one of the at least one memory device storing a body of information;
at least one processor in communication with the at least one memory device and having access to the body of information;
a display device in communication with the at least one processor;
a first user input means for interfacing with the display device and being in communication with the at least one processor;
a computer-readable storage medium storing a plurality of software instructions; and
a first retrieval means in communication with the at least one processor and configured for retrieving at least one of the plurality of software instructions from the computer-readable storage medium,
wherein the at least one processor is configured for retrieving the at least one of the plurality of software instructions from the computer-readable storage medium via the first retrieval means and storing the software instructions in the at least one memory device; and
wherein the software instructions when executed by the at least one processor cause the computing system to:
display on the display device an on-display reference to the body of information and an on-display indicator representing the first input means; and
replace at least a first portion of the on-display reference with a search box configured for receiving alphanumeric search information when an on-display indicator of the at least a first user input means to the computing system designates the on-display reference on the display device.

2. The computing system of claim 1, wherein the search box is configured for receiving the alphanumeric search information from a second user input means.

3. The computing system of claim 2, wherein the first user input means is a digital mouse and the second input means is a digital keyboard.

4. The computing system of claim 2, wherein the first and second user input means are the same means and the second input means is a digital keyboard.

5. The computing system of claim 1, wherein the computer-readable storage medium has further software instructions stored thereon which when executed by the at least one processor cause the computing system to:
conduct a search for the alphanumeric search information within the body of information;
receive search results in response to the alphanumeric search information received in the search box; and
present the search results on the display device.

6. The computing system of claim 1, wherein the body of information is at least one of a database, a body of alphanumeric text, a collection of graphics images, and a collection of data file names.

7. The computing system of claim 1, wherein the on-display reference is at least one of alphanumeric text, a graphics image and a tab.

8. The computing system of claim 1, wherein the on-display indicator is a graphic indicator relocatable on the display device by the first input means.

9. The computing system of claim 1, wherein the designating of the on-display reference by the on-display indicator comprises the on-display indicator hovering over the on-display reference without selecting the on-display reference.

10. The computing system of claim 5, wherein the on-display reference includes a plurality of subject references associated with a subset of the body of information, each of the subject references associated with a subset of the body of information, and the search conducted for the alphanumeric information is conducted within the subset designated when the on-display indicator of the at least a first user input means to the computing system designates one of the plurality of subject references.

11. A computer-readable storage medium, with software instructions stored thereon, which when executed by at least one processor of a computing system with access to a body of information, cause the computing system to:
display on a display device in communication with the computing system an on-display reference to the body of information; and
replace at least a first portion of the on-display reference with a search box configured for receiving alphanumeric search information when an on-display indicator of a first user input means to the computing system designates the on-display reference.

12. The computer-readable storage medium of claim 11, with further software instructions stored thereon which when executed by the at least one processor cause the computing system to:
display the alphanumeric search information in the search box when the alphanumeric search information is input by a user into the computing system via a second user input means;
conduct a search for the alphanumeric search information within the body of information;
receive search results in response to the alphanumeric search information received in the search box; and
present the search results on the display device.

13. The computer-readable storage medium of claim 11, wherein the body of information is at least one of a database, a body of alphanumeric text, a collection of graphics images, and a collection of data file names.

14. The computer-readable storage medium of claim 11, wherein the on-display reference is at least one of alphanumeric text, a graphics image and a tab.

15. The computer-readable storage medium of claim 11, wherein the on-display indicator is a graphic indicator relocatable on the display device by the first input means.

16. The computer-readable storage medium of claim 15, wherein the first user input means is a digital mouse and the second input means is a digital keyboard.

17. The computer-readable storage medium of claim 12, with further software instructions stored thereon which when executed by the at least one processor, cause the computing system to display the on-display reference including a plurality of subject references, each of the subject references being associated with a subset of the body of information, and cause the computing system to search for the alphanumeric information within the subset designated when the on-display indicator of the at least a first user input means to the computing system designates one of the plurality of subject references.

18. A method for searching a body of information accessible to a computing system, the method comprising:
operating the computing system to display on a display device in communication with the computing device an on-display reference to the body of information;
operating a first user input means to the computing system to cause an on-display indicator of the first input means to designate the on-display reference; and
automatically replacing at least a portion of the on-display reference with a search box configured for receiving alphanumeric search information when the on-display indicator designates the on-display reference.

19. The method of claim 18, further comprising:
conducting a search for the alphanumeric search information within the body of information;
receiving search results in response to the alphanumeric search information received in the search box; and
presenting the search results on the display device.

20. The method of claim 19, wherein the conducting the search for the alphanumeric search information within the body of information comprises at least one of conducting a search for the alphanumeric search information within a database, within a body of alphanumeric text, among a collection of graphics images, and among a collection of data file names.

21. The method of claim 19, wherein the conducting the search for the alphanumeric search information within the body of information comprises entering the alphanumeric search information into the computing system via a second user input means and displaying the alphanumeric search information in the search box.

22. The method of claim 21, wherein entering the alphanumeric search information into the computing system comprises entering the search information into the computing system via a digital keyboard.

23. The method of claim 22, wherein operating the first user input means comprises operating a digital mouse.

24. The method of claim 18, wherein operating the computing system to display the on-display reference comprises operating the computing system to display at least one of alphanumeric text, a graphics image and a tab.

25. The method of claim 18, wherein operating the first input means to cause the on-display indicator to designate the on-display reference comprises operating the first input means to cause a graphic indicator relocatable on the display device by the first input means to designate the on-display reference.

26. The method of claim 19, the on-display reference includes a plurality of subject references associated with a subset of the body of information, each of the subject references associated with a subset of the body of information, and the search is conducted for the alphanumeric information is conducted within the subset designated when the on-display indicator of the at least a first user input means to the computing system designates one of the plurality of subject references.

27. A graphic user interface for searching a body of information by means of a computing system having a display device and a first user input means, the graphic user interface displayed on the display device and comprising:
an on-display reference to the body of information;
an on-display indicator of the first user input means; and
a search box for receiving alphanumeric search input,
wherein the computing system is configured for replacing the on-display reference at least in part by the search box when the on-display indicator designates the on-display reference on the display device.

28. The graphic user interface of claim 27, wherein the computing system is configured for displaying within the search box a cursor associated with a second user input means, the cursor indicating a location for entering alphanumeric information by means of the second input means.

29. The graphic user interface of claim 28, wherein the first input means is a digital mouse and the second input means is a digital keyboard.

30. The graphic user interface of claim 28, wherein the first input means and the second input means are the same input means and the first input means is a digital keyboard.

31. The graphic user interface of claim 27, wherein the computing system is configured for displaying a plurality of subject references, each of the subject references associated with a subset of the body of information, and the search conducted for the alphanumeric information is conducted within the subset designated when the on-display indicator of the at least a first user input means to the computing system designates one of the plurality of subject references.
